(19) United States
(12) Patent Application Publication
(10) Pub. No.: US 2020/0311625 A1
(43) Pub. Date: Oct. 1, 2020

(54) DETERMINING A NEXUS SCORE OF DIGITAL ASSETS

(71) Applicant: International Business Machines Corporation, Armonk, NY (US)

(72) Inventors: Michael Bender, Rye Brook, NY (US); Stan K. Daley, Atlanta, GA (US); Gordan G. Greenlee, Endicott, NY (US)

(21) Appl. No.: 16/372,234

(22) Filed: Apr. 1, 2019

(51) Int. Cl. G06Q 10/06; G06Q 30/02

(52) U.S. Cl. CPC G06Q 10/067; G06Q 30/0278

(57) ABSTRACT

A disposition system in which a location and description of a digital asset can be tracked to allow for a future change in ownership or deletion of a digital asset, as well as an impartial valuation of the digital asset relative to a nexus of the possible new owners with the digital asset and/or the owner of the digital asset. disposition system securely values digital assets based on inputted events.

### BACKGROUND

The present invention relates to digital assets, and more specifically to determining a value of a digital asset relative to identified individuals, group of individuals, entity or group of entities, and providing a recommendation regarding allocation of the digital asset to the identified individuals, group of individuals, entity or group of entities.

Assets of people are becoming increasingly digital in nature, with most documents, bank accounts and other assets being stored digitally. Most of the assets are protected or secured through passwords or other authentication means. A digital asset can include digital photographs, digital works of arts or images which have been edited or altered digitally, designs for an object, digital documents or articles, sound recordings, purchases, websites, website domains, e-mail accounts, social media accounts, data associated with digital appliances (e.g. recipes), or data to access digital records such as, but not limited to financial accounts, or other data stored digitally. Therefore, a digital asset is an object which exists in digital format and has associated rights, such as rights to use, copy, display or perform, or distribute copies. The associated rights could comprise copyright, trademark, patent or trade secret rights. Digital assets may also provide access to financial assets.

Digital assets can be owned by an individual or group of individuals, an entity or a group of entities. Entities can include, but are not limited to: companies, foundations, estates, organizations, institutions, universities and other organized groups of people.

Digital assets need to be tracked and valued at certain points in time, and the value needs to be determined based on a trusted, impartial source. Ownership of digital assets can change. For example, the digital asset can be gifted from an owner to another individual, from an owner to a group of individuals, from an owner to an entity, or from an owner to a group of entities. The ownership of the digital assets can also change due to other events, such as entry of a new individual to a group, status change of an owner, disbanding of a group of individuals or group of entities, an owner leaving a group, an owner being unavailable, destruction of a digital asset or theft of a digital asset.

While financial valuations are easily applied to or can be systematically applied to some assets, other assets are more difficult to evaluate and express a value for. The valuation of digital assets may be necessary for taxation purposes, insurance purposes, as well as distribution of assets when an owner or entity is no longer available (i.e. distribution to one or more beneficiaries) or has left a group of individuals or a group of entities or an entity.

With different entities and individuals valuing an owner's digital assets differently, determining a valuation and/or distribution of the digital assets is not easily determined.

### SUMMARY

According to one embodiment of the present invention, a method of determining a recommendation for allocation of a digital asset comprising an object which exists in a digital format and is associated with a right to use, based on an event which impacts the right to use the digital asset by an owner of the digital asset is disclosed. The method comprising: receiving input regarding the event; determining at least one digital asset affected by the event; calculating a nexus score representing a relative affinity of a nexus between the digital asset and identified individuals and entities other than the owner of the digital asset; associating the digital asset and potential new owners of the digital asset; evaluating a value associated with the digital asset relative to the potential new owners; and determining a recommendation of distribution of the digital assets to the potential new owners.

According to another embodiment of the present invention, a method of determining a score representing a magnitude of a nexus of at least one individual and/or at least one entity other than an owner with a digital asset is disclosed. The method comprising determining a relationship of an identified individual and/or at least one entity with the digital asset of the owner; determining nonobvious relationships associated with the digital asset; building a model of the direct relationships and the nonobvious relationships associated with the digital asset; assigning a score to the direct relationships and the nonobvious relationships of the model representative of a relative affinity of a nexus between identified individuals and entities other than the owner of the digital asset to the digital asset; determining whether additional weight has been assigned to an identified identify or entity relative to the digital asset; and altering the score for each additional weight assigned.

According to another embodiment of the present invention, a method of receiving and classifying digital assets of an owner is disclosed. The method comprising: receiving digital assets with associated metadata from the owner of the digital asset; receiving allocation rules with classification criteria to be applied to the digital assets received; applying allocation rules and classification criteria to the digital assets received to generate a metadata tiered classification model of the digital assets; calculating a nexus score for each digital asset representing a relative affinity of a nexus between identified individuals and entities other than the owner of the digital asset to the digital asset; determining a value of the digital asset to each of the identified individuals and/or entities; and determining a recommendation for distribution of the digital assets to the identified individuals and/or entities.

According to another embodiment of the present invention, a computer program product of a disposition system for determining a recommendation for allocation of a digital asset comprising an object which exists in a digital format and is associated with a right to use, based on an event which impacts the right to use the digital asset by an owner of the digital asset is disclosed. The disposition system comprising: at least one computer comprising at least one processor, one or more memories, one or more computer readable storage media, the computer program product comprising a computer readable storage medium having program instructions embodied therewith, the program instructions executable by the computer to perform a method. The method comprising: receiving, by the computer, input regarding the event; determining, by the computer, at least one digital asset affected by the event; calculating, by the computer, a nexus score representing a relative affinity of a nexus between the digital asset and identified individuals and entities other than the owner of the digital asset; associating, by the computer, the digital asset and potential new owners of the digital asset; evaluating, by the computer, a value associated with the digital asset relative to the potential new owners; and determining, by the computer, a recommendation of distribution of the digital assets to the potential new owners.

According to an embodiment of the present invention, a computer system for determining a recommendation for allocation of a digital asset comprising an object which exists in a digital format and is associated with a right to use, based on an event which impacts the right to use the digital asset by an owner of the digital asset is disclosed. The compute system comprising a computer comprising at least one processor, one or more memories, one or more computer readable storage media having program instructions executable by the computer to perform the program instructions. The program instructions comprising: receiving, by the computer, input regarding the event; determining, by the computer, at least one digital asset affected by the event; calculating, by the computer, a nexus score representing a relative affinity of a nexus between the digital asset and identified individuals and entities other than the owner of the digital asset; associating, by the computer, the digital asset and potential new owners of the digital asset; evaluating, by the computer, a value associated with the digital asset relative to the potential new owners; and determining, by the computer, a recommendation of distribution of the digital assets to the potential new owners.

According to another embodiment of the present invention, a computer program product of a disposition system for determining a score representing a magnitude of a nexus of at least one individual and/or at least one entity other than an owner with a digital asset is disclosed. The disposition system comprising: at least one computer comprising at least one processor, one or more memories, one or more computer readable storage media, the computer program product comprising a computer readable storage medium having program instructions embodied therewith, the program instructions executable by the computer to perform a method. The method comprising: determining, by the computer, a relationship of an identified individual and/or at least one entity with the digital asset of the owner; determining, by the computer, nonobvious relationships associated with the digital asset; building, by the computer, a model of the direct relationships and the nonobvious relationships associated with the digital asset; assigning, by the computer, a score to the direct relationships and the nonobvious relationships of the model representative of a relative affinity of a nexus between identified individuals and entities other than the owner of the digital asset to the digital asset; determining, by the computer, whether additional weight has been assigned to an identified identify or entity relative to the digital asset; and altering, by the computer, the score for each additional weight assigned.

According to another embodiment of the present invention, a computer system for determining a score representing a magnitude of a nexus of at least one individual and/or at least one entity other than an owner with a digital asset is disclosed. The computer system comprising a computer comprising at least one processor, one or more memories, one or more computer readable storage media having program instructions executable by the computer to perform the program instructions. The program instructions comprising: determining, by the computer, a relationship of an identified individual and/or at least one entity with the digital asset of the owner; determining, by the computer, nonobvious relationships associated with the digital asset; building, by the computer, a model of the direct relationships and the nonobvious relationships associated with the digital asset;

assigning, by the computer, a score to the direct relationships and the nonobvious relationships of the model representative of a relative affinity of a nexus between identified individuals and entities other than the owner of the digital asset to the digital asset; determining, by the computer, whether additional weight has been assigned to an identified identify or entity relative to the digital asset; and altering, by the computer, the score for each additional weight assigned.

According to another embodiment of the present invention, a computer program product of a disposition system for receiving and classifying digital assets of an owner is disclosed. The disposition system comprising: at least one computer comprising at least one processor, one or more memories, one or more computer readable storage media, the computer program product comprising a computer readable storage medium having program instructions embodied therewith, the program instructions executable by the computer to perform a method. The method comprising: receiving, by the computer, digital assets with associated metadata from the owner of the digital asset; receiving, by the computer, allocation rules with classification criteria to be applied to the digital assets received; applying, by the computer, allocation rules and classification criteria to the digital assets received to generate a metadata tiered classification model of the digital assets; calculating, by the computer, a nexus score for each digital asset representing a relative affinity of a nexus between identified individuals and entities other than the owner of the digital asset to the digital asset; determining, by the computer, a value of the digital asset to each of the identified individuals and/or entities; and determining, by the computer, a recommendation for distribution of the digital assets to the identified individuals and/or entities.

According to another embodiment of the present invention, a computer system for receiving and classifying digital assets of an owner is disclosed. The computer system comprising a computer comprising at least one processor, one or more memories, one or more computer readable storage media having program instructions executable by the computer to perform the program instructions. The program instructions comprising:

receiving, by the computer, digital assets with associated metadata from the owner of the digital asset; receiving, by the computer, allocation rules with classification criteria to be applied to the digital assets received; applying, by the computer, allocation rules and classification criteria to the digital assets received to generate a metadata tiered classification model of the digital assets; calculating, by the computer, a nexus score for each digital asset representing a relative affinity of a nexus between identified individuals and entities other than the owner of the digital asset to the digital asset; determining, by the computer, a value of the digital asset to each of the identified individuals and/or entities; and determining, by the computer, a recommendation for distribution of the digital assets to the identified individuals and/or entities.

### BRIEF DESCRIPTION OF THE DRAWINGS

FIG. 1 depicts an exemplary diagram of a possible data processing environment in which illustrative embodiments may be implemented.

FIG. 2 illustrates internal and external components of a client computer and a server computer in which illustrative embodiments may be implemented.

FIG. 3 shows a flow diagram of a method of receiving and classifying digital assets of an owner.

FIG. 4 shows a flow diagram of a method of providing a disposition allocation recommendation based on an event.

FIG. 5 shows a flow diagram of a method of step 208 of FIG. 3 of generating a nexus score.

### DETAILED DESCRIPTION

In an embodiment of the present invention, it will be recognized that a location and description of a digital asset can be tracked to allow for a future change in ownership or deletion of a digital asset, as well as an impartial valuation of the digital asset relative to a nexus of the possible new owners with the digital asset and/or the owner of the digital asset.

In another embodiment of the present invention, it will be recognized that the disposition system securely values digital assets at different points of the life cycle of the owner.

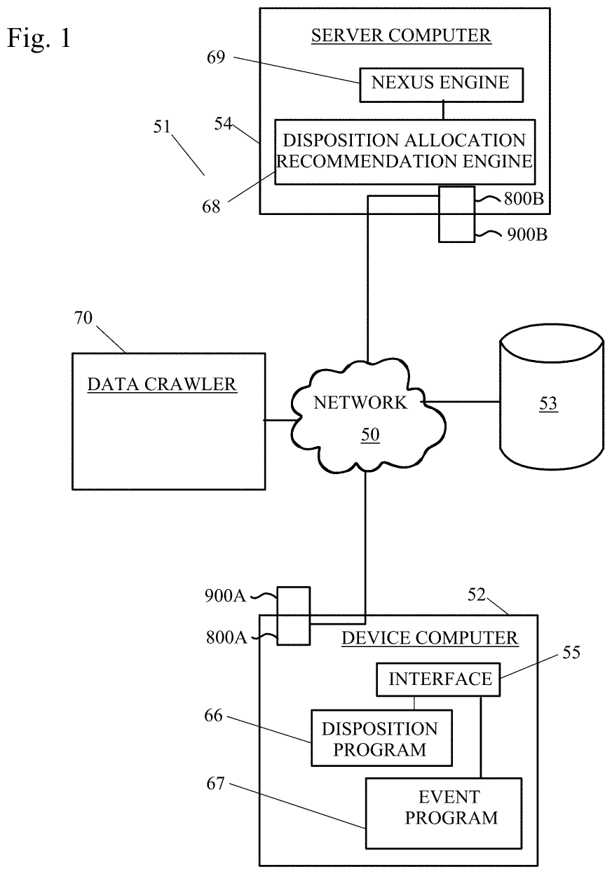

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computer 52, a repository 53, a data crawler 70, and a server computer 54 connect to network 50. In other exemplary embodiments, network data processing system 51 may include additional client or device computers, storage devices or repositories, server computers, and other devices not shown.

The device computer 52 may contain an interface 55, which may accept commands and data entry from an owner or other user. The commands may be regarding digital assets, data associated with the digital assets, classification of the digital assets according to preset rules or schemes, allocation rules associated with the digital assets, associated beneficiaries of the digital assets, and events relating to the owner of the digital assets. The interface can be, for example, a command line interface, a graphical user interface (GUI), a natural user interface (NUI) or a touch user interface (TUI). The device computer 52 preferably includes a disposition program 66 and an event program 67.

The disposition program 66 can receive owner entered metadata regarding digital assets, allocation of such digital assets, allocation rules and any weights associated with the digital assets. The disposition program 66 can additionally apply a designated classification system to the metadata and associated assets. The disposition program 66 can provide input to a nexus engine 69 described below. The disposition program 66 can receive a report regarding a disposition allocation recommendation of digital assets to identified individuals or entities.

The event program 67 can receive events and determine whether the events are applicable to a single owner or entity or to a group of owner and/or entities. The event program 67 can also in some cases verify the event and associated consequences of the event. The event program 67 can provide and receive input from the data crawler 70. The event program 67 can interact with to receive or provide input to the nexus engine 69 and the disposition allocation recommendation engine 68.

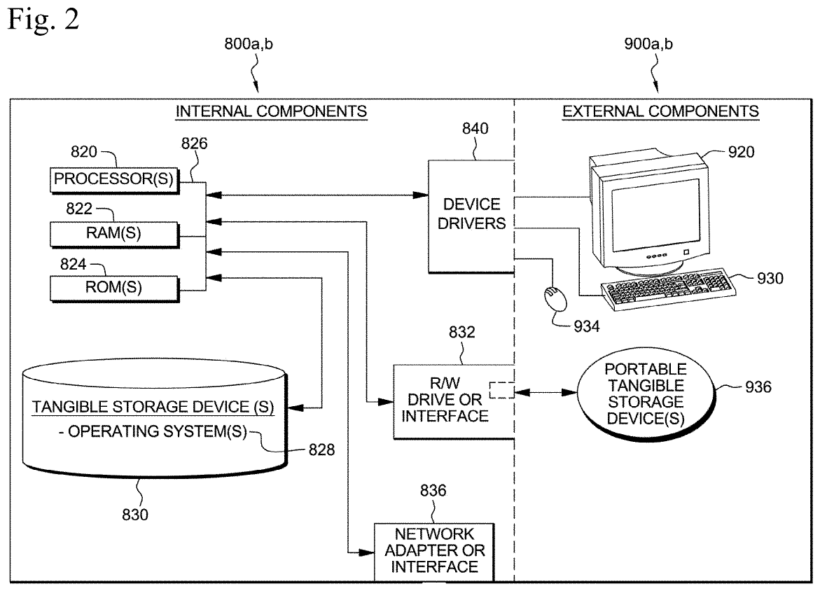

While not shown, it may be desirable to have the disposition program 66 and/or the event program 67 be present on the server computer 54. The device computer 52 includes a set of internal components 800a and a set of external components 900a, further illustrated in FIG. 2.

Server computer 54 includes a set of internal components 800b and a set of external components 900b illustrated in FIG. 2. The server computer can be a directory server. The server computer 54 preferably includes a disposition allocation recommendation engine 68 and a nexus engine 69.

The nexus engine 69 can receive input from data crawler 70, event program 67 and the disposition program 66. The nexus engine 69 calculates and determines a nexus score for each digital asset. The nexus engine 69 can additional equate a nexus score with a value of the asset relative to a user, a group of user, an entity or a group of entities that may assume ownership of the digital asset due to an event. The nexus engine 69 can provide input to the disposition allocation recommendation engine 68. In an alternate embodiment, the disposition allocation recommendation engine 68 could equate a nexus score with a value of the asset relative to a user, a group of user, an entity or a group of entities that may assume ownership of the digital asset due to an event.

The disposition allocation recommendation engine 68 generates and outputs a recommendation to an owner of a digital asset or a third party regarding allocation of the digital assets. The recommendation can be sent to the owner, a third party or a prospective or to-be owner via the disposition program 66. The disposition allocation recommendation engine 68 can receive input from the nexus engine 69, the disposition program 66 and the event program 67.

In the depicted example, server computer 54 provides information, such as boot files, operating system images, and applications to the device computer 52. Server computer 54 can compute the information locally or extract the information from other computers on network 50. The server computer 54 may contain the event program 67 and/or the disposition program 66.

The disposition program 66, the event program 67, the disposition allocation recommendation engine 68 and the nexus engine 69 are all part of a disposition system 71.

The disposition system 71 can additionally include a data crawler 70 with access to published, public information and records; a report builder; and a secure repository, such as repository 53 which employs security such as, but not limited to blockchain, encrypted keys or hashes. While the repository 53 is shown separately from the server computer 54, the server computer 54 can be a directory server in which a change log remains in persistence within a blockchain.

The data crawler 70, while shown separately in FIG. 1, can also be integrated into the nexus engine 69, the event program 67 and/or the disposition program 66.

Program code, engines, and programs such as disposition program 66, event program 67, disposition allocation recommendation engine 68 and nexus engine 69 may be stored on at least one of one or more computer-readable tangible storage devices 830 shown in FIG. 2, on at least one of one or more portable computer-readable tangible storage devices 936 as shown in FIG. 2, or in a repository 53 connected to network 50, or may be downloaded to a device computer 52 or server computer 54, for use. For example, program code, engines and programs such as disposition program 66, event program 67, disposition allocation recommendation engine 68 and nexus engine 69 may be stored on at least one of one or more storage devices 830 on server computer 54 and downloaded to device computer 52 over network 50 for use. Alternatively, server computer 54 can be a web server, and the program code, engines, and programs such as disposition program 66, event program 67, disposition allocation recommendation engine 68 and nexus engine 69 may be stored on at least one of the one or more storage devices 830 on server computer 54 and accessed device computer 52. In other exemplary embodiments, the program code, engines, and programs such as disposition program 66, event program 67, disposition allocation recommendation engine 68 and nexus engine 69 may be stored on at least one of one or more computer-readable storage devices 830 on device computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

FIG. 2 illustrates internal and external components of a device computer 52 and server computer 54 in which illustrative embodiments may be implemented. In FIG. 2, a device computer 52 and a server computer 54 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, disposition allocation recommendation engine 68 and nexus engine 69, and disposition program 66 and event program 67 are stored on one or more of the computer-readable tangible storage devices 830 for execution by one or more of the processors 820 via one or more of the RAMs 822 (which typically include cache memory). In the embodiment illustrated in FIG. 2, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Disposition allocation recommendation engine 68, nexus engine 69, disposition program 66 and event program 67 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Disposition allocation recommendation engine 68, nexus engine 69, disposition program 66, and event program 67 can be downloaded to the device computer 52 and server computer 54 from an external computer via a network (for example, the Internet, a local area network or other, wide area network) and network adapter or interface 836. From the network adapter or interface 836, disposition allocation recommendation engine 68, nexus engine 69, disposition program 66, and event program 67 is loaded into hard drive 830. Disposition allocation recommendation engine 68, nexus engine 69, disposition program 66, and event program 67 can be downloaded to the server computer 54 from an external computer via a network (for example, the Internet, a local area network or other, wide area network) and network adapter or interface 836. From the network adapter or interface 836, disposition allocation recommendation engine 68, nexus engine 69, disposition program 66, and event program 67 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Disposition allocation recommendation engine 68, nexus engine 69, disposition program 66, and event program 67 can be written in various programming languages including low-level, high-level, object-oriented or non object-oriented languages. Alternatively, the functions of a disposition allocation recommendation engine 68, nexus engine 69, disposition program 66, and event program 67 can be implemented in whole or in part by computer circuits and other hardware (not shown).

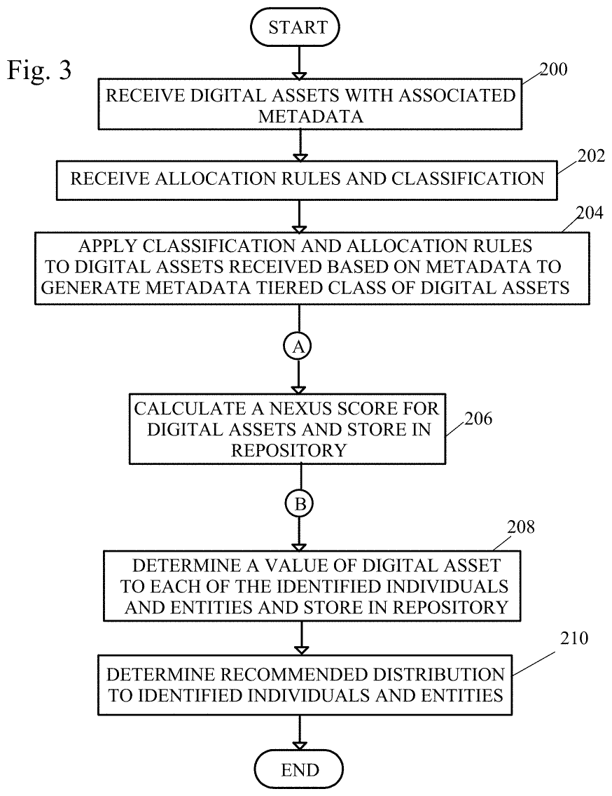

FIG. 3 shows a flow diagram of a method of receiving and classifying digital assets of an owner.

In a first step, the disposition program 66 of the disposition system 71 receives digital assets with associated metadata from an owner of the digital asset (step 200). The digital assets and associated metadata can be entered by the owner themselves or a third party at the direction of an owner. In an alternate embodiment, the owner can schedule the disposition program 66 to determine if any digital assets have been newly added or updated removing the burden from the owner to manually enter any updates or new digital assets created.

The metadata can include a type of digital asset from categories set by the owner of predefined categories.

The metadata can also include information regarding who created the digital asset. For example, the photographer of digital image, the videographer of a video, author(s) of a published article, the creator of a financial account or social media account.

The metadata can also include individual(s) or entities which contributed to the digital asset. For example, a company which may have donated equipment or funds to a research project associated with a published article, an editor of a digital image; a director or screenwriter of a video.

The metadata can also include dates establishing time periods of: renewal of a service or a property associated with the digital asset, creation of the digital asset, creation of at least a portion of the digital asset, creation of image in which the digital asset represents, when the digital asset may have been last updated or other associated dates related to the digital asset.

The metadata can additionally include a location of the digital asset including, but not limited to where the digital asset is stored, where copies of the digital asset are stored, and associated security and login information associated with the digital asset. It should be noted that passwords can be updated manually or through a scheduled process as discussed above.

The disposition program 66 receives allocation rules with classification criteria to be applied to the digital assets received (step 202). The allocation rules specifically dictate how the digital assets are to be allocated based on a possible event or a series of possible events designated by the owner. The allocation rules can include identification of a specific possible owner(s) of a digital asset. Additionally, the allocation rules can designate whether a digital asset can or should be copied, ownership transferred including any necessary access or login information, or the digital asset deleted. The allocation rules can be a preset set of a rules or based on a document or a series of documents. For example, the document could be a contract or written agreement between an owner and a company in regards to a digital asset. In another example, the document could be last will and testament of the owner. The classification criteria can include rules regarding the allocation of a certain type of digital asset.

In one embodiment, digital copies of intellectual property could be transferred from a first company to at least a second company upon the formal signing of a sales agreement with allocation rules within the sales agreement designated the exact details of the transfer. In a second embodiment, a “secret” family recipe could be the digital asset and shared with the children and grandchildren. In another embodiment, control of social media accounts could be delegated to specific person, such as a trusted friend.

Next, the allocation rules and associated classification criteria are applied by the disposition program 66 to the digital assets received to generate a metadata tiered classification of digital assets received (step 204). In an embodiment of the present invention, the classification system of the digital assets is based on industry standards regarding control of digital rights associated with licensing and allowable usage.

For example,
Social media
   Email
   Chat applications
   Facebook
Digital documents
   Cloud Storage
Digital images
   Mobile Device
   Cloud storage
Music
   Cloud server
   Registered Sites
Financial Instruments
   Brokerage Account
   Bank Accounts
Digital videos
   Cloud storage
Intellectual Property
   Patents
   Documentation for critical processes
   Copies of software programs
Business Licenses
   Software licenses
   Support licenses

The nexus engine 69 of the disposition system 71 then calculates a nexus score for each digital asset and the nexus score is stored in a secure or encrypted repository, for example repository 53 (step 206). A nexus score is a numerical expression of the relative magnitude or affinity of a nexus between identified individuals and entities, other than the owner of the digital asset, to a digital asset. The nexus score is preferably calculated based on the metadata of the digital asset, the digital asset itself, indirect relationships of individuals or entities to the digital assets, nonobvious relationships of individuals or entities to the digital asset, and weights assigned by the owner of the digital asset.

The disposition allocation recommendation engine 68 determines a value of the digital asset to each of the identified individuals and entities and stores the value in secure or encrypted repository, for example repository 53 (step 208). In an alternate embodiment, the disposition program 66 can execute step 208. The value of the digital asset is calculated based on different references as well as the asset classification and metadata of the digital asset.

For example, using the metadata of the digital assets would allow for lookups of comparable value to other such digital assets which have been recently sold. If desired, the available metadata could be used to generate a formal appraisal from a qualified professional in the related space. Other assets can be valued by reference schedules or a designated type or processing, such as, but not limited to generic schedules by asset class, auction comparisons and appraisals. Digital assets associated with financial instruments can be calculated by accessing websites that store the instruments, for example, using user identification and password of the owner to retrieve a stock portfolio from a brokerage. The type of pricing can include, but is not limited to insurability, estate planning, high/low.

Based on the value of the digital assets and the associated nexus score, the disposition allocation recommendation engine 68 determines a recommendation for distribution of the digital assets to other individuals, group of individuals, entities or group of entities (step 210) and the method ends. The recommendation can include, but is not limited to: to whom a digital asset or a copy should be sent, to whom ownership is to be transferred (including any necessary access or login information), a ranking of the individuals or entities to receive the digital assets, or if the digital asset was deleted.

In an alternate embodiment, prior to the method ending, a report regarding the nexus score, identified individuals and entities and value associated with the digital assets and a value can be produced and sent to the owner, a third party and/or the identified individuals and entities. This information can assist a trusted indivudal in allocating non-tangible assets.

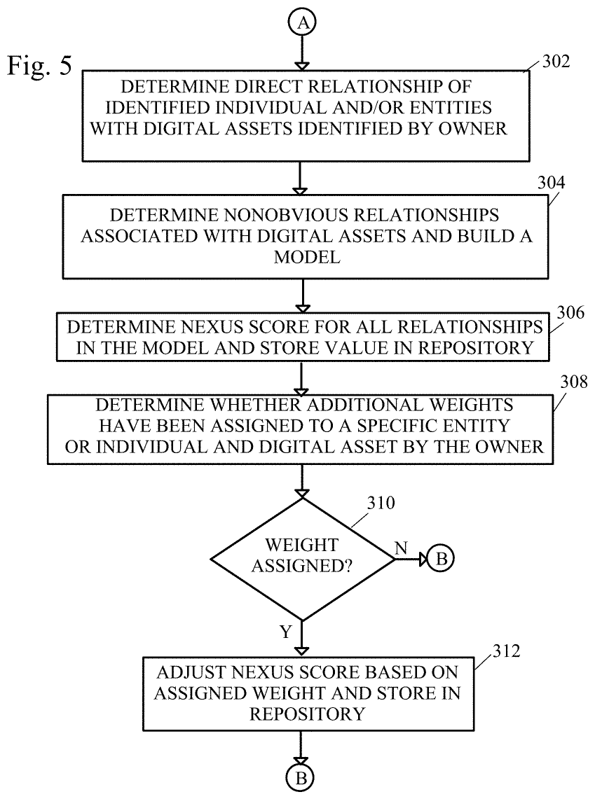

FIG. 5 shows a flow diagram of a method of step 208 of FIG. 3 of generating a nexus score.

In a first step, the nexus engine 69 determines direct relationships of individuals and/or entities with digital assets identified by owner (step 302). A direct relationship is defined as an individual, groups of individual, entity or group of entities which participated in creation of, is a part of the digital asset (i.e. appears in an image), attended an event where the digital asset was created (e.g. working session where digital asset was created) editing of, contribution of or monetary purchase of a digital asset.

The nexus engine 69 then determines nonobvious relationships associated with the digital assets based on data mining, for example via the data crawler 70 using nonobvious relationship awareness (NORA) and the metadata associated with the digital assets to build a model of identities and relationships of the identities associated with individuals and/or entities in real time (step 304). The model preferably includes both direct relationships and nonobvious relationships and can be associated with the nexus score. Cognitive analysis can also be used to determine interest in a digital asset by using the individuals present in at least one digital asset to determine other digital assets created within a same time period or location with unidentified participants. The data crawler 70 mines data from published information, such as, but not limited to published articles, social media feeds, blogs, forums, auctions, public databases, public records, published standards, and other information.

For each of the relationships of the model, the nexus engine 69 assigns a nexus score, and stores the value in a repository, such as secure repository 53 (step 306). The nexus score is a score of a value representative of a magnitude of affinity of an individual, group of individuals, entity or group of entities with a connection or a series of connections with a digital asset or an owner of a digital asset.

The nexus engine 69 then determines whether any additional weights have been assigned by the owner to a particular individual and/or entity with the digital asset (step 308). The weight may be added to either increase or decrease the magnitude of relationship with an individual and/or entity with a digital asset. For example, an increased weight may be added to an individual who may not have a direct relationship with a digital asset, but the owner has specific wishes towards.

If a weight has been assigned by the owner (step 310), based on the weight assigned, the nexus score is altered or adjusted by the nexus engine 69 and the updated nexus score is stored in the repository, for example secure repository 53 (step 312), and the method continues with step 208 of FIG. 3.

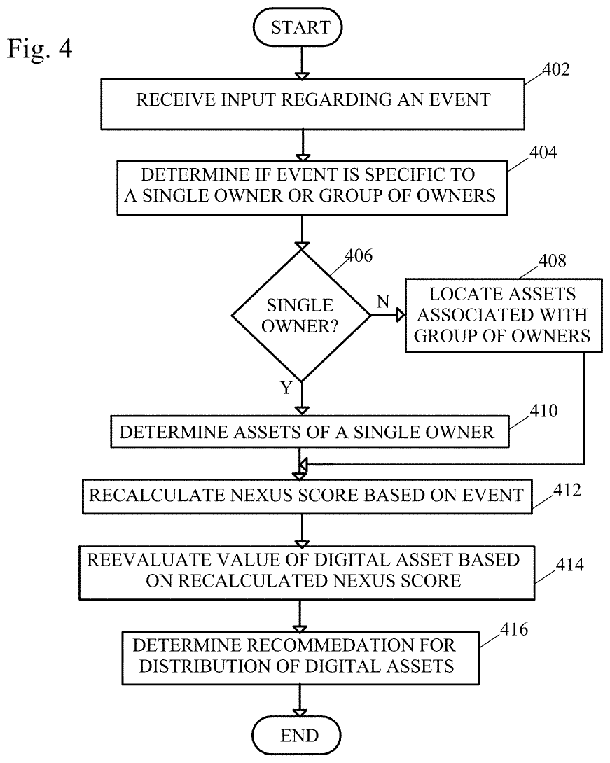

FIG. 4 shows a flow diagram of a method of providing a disposition allocation recommendation based on an event.

In a first step, input regarding an event is received (step 402), for example by the disposition allocation recommendation engine 68 and/or the event program 67. The input regarding the event may be received through manual input from the owner of the digital assets, a third party associated with the owner of the assets, such as an executor or an insurance claim, based on a predetermined schedule, or requested by the owner. Alternatively, the event may be received from a data crawler, such as data crawler 70 which monitor for, and analyze public records to determine whether an event has occurred. The data crawler 70 can then feed data regarding an event(s) to the disposition allocation recommendation engine 68 and/or the event program 67. The event may be related to a single owner or multiple owners.

The disposition allocation recommendation engine 68 then determines if the event received is specific to a single owner or to a group of owners (step 404). The engine 68 can evaluate through machine learning and an associated training period what events may be relevant to only a single owner versus multiple or a group owners. For example, natural disasters may affect a group of owners in a specific geographic area, or there might be a contract between multiple parties.

If the disposition allocation recommendation engine 68 determines that the event received is associated with only a single owner (step 406), the engine 68 determines or locates the digital assets of the single owner affected by the event (step 410) and the method continues with step 412.

If the disposition allocation recommendation engine 68 determines that the event received is associated with a group of owners (step 406), the engine 68 determines or locates the digital assets of the group of owners affected by the event (step 408) and the method continues with step 412.

For example, if multiple people were present at a wedding and everyone shared their images to a social media account or other centralized place, associations can be determined with images from the combined group as opposed to a single source. In a business scenario, posts and emails from a group of individuals can be used to determine whom should get access to specific documents.

In step 412, the nexus score is recalculated based on the event and the recalculated nexus score is stored in the secure repository, such as repository 53 (step 412). The nexus score may be calculated by steps 302 through steps 312 of FIG. 5. The event may or may not influence a nexus score for a digital asset.

Next, the disposition allocation recommendation engine 68 reevaluates the value of the digital asset based on the recalculated nexus score and stores the revaluation in the secure repository, such as repository 53 (step 414). The value of the digital asset is calculated based on different references as well as the asset classification and metadata of the digital asset.

Based on the reevaluation of the value of the digital assets and the associated nexus score, the disposition allocation recommendation engine 68 determines a recommendation for distribution of the digital assets to individuals, groups of individuals, entities or groups of entities (step 416), and the method ends. The recommendation for distribution may be stored in the secure repository 53. Prior to the method ending, a report with the recommendation for distribution can be sent to the owner, a third party, or the individuals or entities to which the digital assets are to be distributed. The report can include data associated with the digital asset such as some or all of the metadata associated with each digital asset.

### EXAMPLES

In a first example, an event, such as a publishing of an obituary, is detected by a web crawler. From the obituary, the disposition system 71 determines that owner A has passed away. Owner A, prior to the event, had included digital assets with the disposition system 71. These digital assets include digital images of Individuals A-D at a party, a video of a farm and its animals, a financial brokerage account, and a social media account,. Owner A provided metadata regarding the images, such as data associated with Individuals A-D in the images, the location within the images, when the images were taken, who took the images, and where the digital images are stored. The metadata associated with the video included the location of the video, and the videographer. The metadata associated with the financial brokerage account includes the username and password for the account, and an identification of the financial institution where the account is held. The social media account metadata includes the username and password. The distribution allocation rules associated with the digital assets included deletion of the social media account, sending the digital images (or transferring rights in the images) to at least the individuals present within them, and sending the video (or transferring rights in the video) to a party who might be interested in the video. The classification of the digital assets may be similar to the classification shown above.

A nexus score is calculated for each of the digital assets. The nexus score for the individuals A-D may be the same for the digital images in which they are present in. Therefore, individual A may have a nexus score of 100 for digital image A in which they are in and individual B may have a nexus score of 75 because they are in other digital images which were taken at the same party on the same day. The nexus engine 69 may have determined that the digital image of the cake and individual A may also be of interest to the chef which prepared the cake through nonobviousness relationship awareness analysis (NORA). The chef may have a nexus score of 45. The value associated with the digital images may be set to be high for the individuals in the digital images and significantly lower of the chef. A recommendation of disposition allocation of the digital image A may be ranked as follows: 1) individual A, 2) individual B and 3) chef.

In another example, the nexus engine 69 may use NORA to determine that a foundation which donates to farms with horses which are used in youth programs would be interested in the video. The nexus score of the video may be high for the foundation and the disposition system 71 would recommend that the rights to the digital video be allocated to the foundation.

In another example, since the owner designated that the social media account be deleted, the disposition system 71 would recommend that the social media account be deleted, and might provide instructions regarding how to delete the social media account.

In another example, during mergers between companies, acquisitions of at least one company, or bankruptcy of a company, the disposition system 71 calculates a nexus score for program code, photos, movies, intellectual properties, manuscripts, documentation, and other artifacts that need to be evaluated and valued to provide a recommendation for possible distribution to an alternate company or entity or other individuals.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of determining a recommendation for allocation of a digital asset comprising an object which exists in a digital format and is associated with a right to use, based on an event which impacts the right to use the digital asset by an owner of the digital asset comprising:
receiving input regarding the event;
determining at least one digital asset affected by the event;
calculating a nexus score representing a relative affinity of a nexus between the digital asset and identified individuals and entities other than the owner of the digital asset;
associating the digital asset and potential new owners of the digital asset;
evaluating a value associated with the digital asset relative to the potential new owners; and
determining a recommendation of distribution of the digital assets to the potential new owners.

2. The method of claim 1, wherein the recommendation includes deletion of the digital asset.

3. The method of claim 1, wherein the recommendation includes distribution of a single asset to multiple new owners.

4. The method of claim 3, wherein the multiple new owners are ranked based on the nexus score.

5. The method of claim 1, wherein the recommendation includes to whom the digital asset can potentially be sent.

6. The method of claim 1, wherein calculated the nexus score comprises:
determining direct relationships of identified potential new owners designated by the owner and associated with the digital asset;
determining nonobvious relationships associated with the digital asset;
building a model of the direct relationships and the nonobvious relationships associated with the digital asset;
assigning a score to the direct relationships and the nonobvious relationships of the model representative of the relative affinity of a nexus between identified individuals and entities other than the owner of the digital asset to the digital asset;
determining whether additional weight has been assigned to an identified identify or entity relative to the digital asset; and
altering the score for each additional weight assigned.

7. The method of claim 6, wherein the nonobvious relationships are determined through nonobvious relationship awareness and data mining

8. The method of claim 1, further comprising determining whether the event affects a single owner or a group of owners.

9. The method of claim 1, wherein the value of the digital asset is calculated based on reference schedules, asset classification and associated metadata, and the nexus score of the digital asset.

10. The method of claim 1, wherein after determining the recommendation of distribution of the digital assets to the potential new owners, further comprising generating a report comprising the nexus score.

11. A method determining a score representing a magnitude of a nexus of at least one individual and/or at least one entity other than an owner with a digital asset comprising:
determining a relationship of an identified individual and/or at least one entity with the digital asset of the owner;
determining nonobvious relationships associated with the digital asset;
building a model of the direct relationships and the nonobvious relationships associated with the digital asset;
assigning a score to the direct relationships and the nonobvious relationships of the model representative of a relative affinity of a nexus between identified individuals and entities other than the owner of the digital asset to the digital asset;
determining whether additional weight has been assigned to an identified identify or entity relative to the digital asset; and
altering the score for each additional weight assigned.

12. The method of claim 11, wherein the nonobvious relationships are determined through nonobvious relationship awareness and data mining

13. A method of receiving and classifying digital assets of an owner comprising:
receiving digital assets with associated metadata from the owner of the digital asset;
receiving allocation rules with classification criteria to be applied to the digital assets received;
applying allocation rules and classification criteria to the digital assets received to generate a metadata tiered classification model of the digital assets;
calculating a nexus score for each digital asset representing a relative affinity of a nexus between identified individuals and entities other than the owner of the digital asset to the digital asset;
determining a value of the digital asset to each of the identified individuals and/or entities; and
determining a recommendation for distribution of the digital assets to the identified individuals and/or entities.

14. The method of claim 13, wherein calculating the nexus score comprises
determining direct relationships of identified potential new owners designated by the owner and associated with the digital asset;
determining nonobvious relationships associated with the digital asset;
building a model of the direct relationships and the nonobvious relationships associated with the digital asset;
assigning a score to the direct relationships and the nonobvious relationships of the model representative of the relative affinity of a nexus between identified individuals and entities other than the owner of the digital asset to the digital asset;
determining whether additional weight has been assigned to an identified identify or entity relative to the digital asset; and
altering the score for each additional weight assigned.

15. The method of claim 13, wherein the value of the digital asset is calculated based on reference schedules, asset classification and associated metadata, and the nexus score of the digital asset.

16. The method of claim 13, wherein after determining the recommendation of distribution of the digital assets to the potential new owners, further comprising generating a report comprising the nexus score.

17. The method of claim 13, wherein the nonobvious relationships are determined through nonobvious relationship awareness and data mining

18. A computer program product of a disposition system for determining a recommendation for allocation of a digital asset comprising an object which exists in a digital format and is associated with a right to use, based on an event which impacts the right to use the digital asset by an owner of the digital asset, the disposition system comprising: at least one computer comprising at least one processor, one or more memories, one or more computer readable storage media, the computer program product comprising a computer readable storage medium having program instructions embodied therewith, the program instructions executable by the computer to perform a method comprising:
receiving, by the computer, input regarding the event;
determining, by the computer, at least one digital asset affected by the event;
calculating, by the computer, a nexus score representing a relative affinity of a nexus between the digital asset and identified individuals and entities other than the owner of the digital asset;
associating, by the computer, the digital asset and potential new owners of the digital asset;
evaluating, by the computer, a value associated with the digital asset relative to the potential new owners; and
determining, by the computer, a recommendation of distribution of the digital assets to the potential new owners.

19. The computer program product of claim 18, wherein the recommendation includes deletion of the digital asset.

20. The computer program product of claim 18, wherein the recommendation includes distribution of a single asset to multiple new owners.

21. The computer program product of claim 20, wherein the multiple new owners are ranked based on the nexus score.

22. The computer program product of claim 20, wherein the recommendation includes to whom the digital asset can potentially be sent.

23. The computer program product of claim 20, wherein calculated the nexus score comprises:
determining direct relationships of identified potential new owners designated by the owner and associated with the digital asset;
determining nonobvious relationships associated with the digital asset;
building a model of the direct relationships and the nonobvious relationships associated with the digital asset;
assigning a score to the direct relationships and the nonobvious relationships of the model representative of the relative affinity of a nexus between identified individuals and entities other than the owner of the digital asset to the digital asset;
determining whether additional weight has been assigned to an identified identify or entity relative to the digital asset; and
altering the score for each additional weight assigned.

24. The computer program product of claim 20, further comprising determining whether the event affects a single owner or a group of owners.

25. The computer program product of claim 20, wherein the value of the digital asset is calculated based on reference schedules, asset classification and associated metadata, and the nexus score of the digital asset.
